(19) United States
(12) Patent Application Publication
(10) Pub. No.: US 2005/0141716 A1
(43) Pub. Date: Jun. 30, 2005

(54) Coherent-states based quantum data-encryption through optically-amplified WDM communication networks

(76) Inventors: Prem Kumar, Skokie, IL (US); Eric Corndorf, Chicago, IL (US); Gregory S. Kanter, Chicago, IL (US); Chuang Liang, Evanston, IL (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/982,196

(22) Filed: Nov. 5, 2004

Related U.S. Application Data
(63) Continuation-in-part of application No. 10/674,241, filed on Sep. 29, 2003.
(60) Provisional application No. 60/517,422, filed on Nov. 5, 2003.
(60) Provisional application No. 60/518,966, filed on Nov. 10, 2003.
(60) Provisional application No. 60/546,638, filed on Feb. 20, 2004.

(51) Int. Cl. H04K 1/00

(52) U.S. Cl. 380/255

(57) ABSTRACT

A quantum cryptographic protocol uses two-mode coherent states that is optically amplifiable, resulting in a polarization independent system that is compatible with the existing WDM infrastructure and which provides secure data encryption suitable for wavelength division multiplexing networks through an in-line amplified line.

### CROSS REFERENCE TO RELATED APPLICATIONS

This application is a continuation in part of copending application Ser. No. 10/674,241, which is entitled “Ultra-Secure, Ultra-Efficient Cryptographic System”, and which was filed on Sep. 29, 2003 and the instant application claims priority of the following provisional applications: Ser. No. 60/517,422, which is entitled “Coherent-States Based Quantum Data-Encryption Through Optically-Amplified WDM Communications Networks”, and which was filed on Nov. 5, 2003; Ser. No. 60/518,966, which is entitled “Coherent-States Based Quantum Data-Encryption Through Optically-Amplified WDM Communications Networks, and which was filed on Nov. 10, 2003; and Ser. No. 60/546,638, which is entitled “Quantum Noise Protected Data Encryption for WDM Networks”, and which was filed on Feb. 20, 2004, and the entirety of these applications is hereby incorporated herein by reference.

### STATEMENT REGARDING FEDERALLY SPONSORED RESEARCH

The United States Government has certain rights to this invention pursuant to Grant No. F30602-01-2-0528 from Defense Advanced Research Projects Agency (DARPA) to Northwestern University.

### BACKGROUND OF THE INVENTION

Field of the Invention—The present invention relates generally to information security, and more particularly to a method and system for achieving the cryptographic objectives of data encryption and key expansion/generation/distribution.

Problems associated with information security have become a major issue in this still emerging openly accessible information society. While cryptography is an indispensable tool in addressing such problems, there are both questions of security and efficiency with the standard cryptographic techniques. The usual cryptographic algorithms utilizing private keys have yet to catch up with the data speed of the Internet fiber backbone, not to mention the projected increase of the fiber data rates in the future. The ones utilizing dual keys are even much slower. The private key algorithms, including DES and AES, are not proved to be secure against all attacks within their key-size limits. The public-key algorithms all rely on the presumed complexity of certain computational problems. Both types of algorithms are vulnerable to advances in computer technology, especially if a quantum computer becomes available. Additional problems arise in their use in a network environment, including key management issues as well as the usefulness and design of the public-key infrastructure.

The currently available quantum cryptographic techniques, based primarily on the well known techniques, have many intrinsic limitations that make them too slow and impractical for long-distance or network communications. The most famous of these proposals was made by Bennett-Brassard (BB84) in C. Bennett and G. Brassard, “Quantum crytpgraphy: Public key distribution and coin tossing” in Proceedings of the IEEE International Conference on Computers, Systems and Signal Processing, Bangalore India, 1984, pp 175-179. In this scheme, two parties are able to remotely agree on a string of binary random numbers known only to each other. These random numbers are stored by the user for later use in a one-time pad (OTP) data encryption or as cryptographic keys in complexity-based encryption.

While OTP encryption does provide provable information-theoritic security on public channels, it is inefficient in the sense that every bit of data to be encrypted requires one bit of the generated one-time pad. This means that the encrypted data transmission rate is limited to the key generation rate. Due to technical and physical limitations, current implementations of BB84 have much lower rate-distance product than is available in traditional telecom channels. One of the major technical problems limiting BB84's key generation rate, and more importantly the rate-distance product, is the protocol's requirement for single-photon states. This requirement is a burden for not only in the generation of such states but also in that such states are acutely susceptible to loss, are not optically amplifiable (in general) and are difficult to detect at high rates.

For the encryption of data with perfect secrecy that cannot be broken with any advance in technology, one may, in principle, employ a one-time pad with a secret key obtained by Bennett-Brassard quantum cryptographic technique for key expansion. Such an approach may be possible; however, it is slow and inefficient because the key length needs to be as long as the data, and it also requires a nearly ideal quantum communication line that is difficult to obtain in long distance commercial systems such as the Internet core. On the other hand, for both military and commercial applications, there are great demands for secret communications that are fast and secure but not necessarily perfectly secure. There are many practical issues, human as well machine based, that would make theoretical perfect security in specific models not so important in real life.

The key lengths of traditional cryptographic algorithms are chosen such that current computers using the best known cracking algorithms will require an unreasonable amount of time to break the cipher. While some algorithms generate keys and/or ciphertext that appear to be secure through computational complexity, only in degenerate cases can any information-theoretic analysis of security be performed. The end result is that cipher cracking algorithms may exist that are much more powerful than a cryptographic protocol is provisioned for. Armed with the inherent measurement uncertainty of non-orthogonal quantum states, several protocols have been proposed offering quantum effects as cryptographic mechanisms. A shortcoming of all these proposed protocols is their inherent inability to be optically amplified.

A further consideration is the nature of the transmission network over which quantum encrypted data is being transmitted. Free space or fiber optic links, such as WDM networks are important because they make up the existing optical telecommunications infrastructure. WDM networks are in-line amplified optical fiber links where many independent “streams” or “channels” of data traffic flow simultaneously. In systems in which quantum-noise protected data encryption is based on varying the polarization-state of light, polarization effects in WDM networks affect the polarization-state of light such that the input polarization state of light into a WDM network is not the same as the output polarization state of light. Moreover, this “transformation” happens in a random way that is difficult to track. Consequently, it is desirable to have a cryptographic communications scheme that is independent of the transmission medium, and in particular that is not based on the polarization-state of light. Moreover, it is desirable that such a communication scheme operate seamlessly over WDM networks.

It is accordingly the primary objective of the present invention that it provide an improved method and system for transmitting encrypted data between first and second locations.

It is another objective of the present invention that it provide a method and system for transmitting encrypted data between first and second locations independently of the transmission medium existing between the two locations.

A further objective of the present invention is that it provide an improved method and system for transmitting encrypted data over WDM networks between first and second locations over any transmission medium such as free-space or optical fiber.

A further objective of the present invention is that encrypted signals, where encryption is provided via the present invention, are able to seamlessly propagate with multiplexed conventional unencrypted channels in a free-space or optical fiber network which may or may not be an optically amplified line using erbium, Raman, semiconductor, parametric, or any other optical amplifier in use today.

Another objective of the present invention is that it provide an encryption/decryption method and system that reduce the requirements on drive electronics.

The apparatus of the system of the present invention must also be of construction which is both durable and long lasting, and it should also require little or no maintenance to be provided by the user throughout its operating lifetime. In order to enhance the market appeal of the apparatus of the present invention, it should also be of inexpensive construction to thereby afford it the broadest possible market. Finally, it is also an objective that all of the aforesaid advantages and objectives be achieved without incurring any substantial relative disadvantage.

### REFERENCES

Background information, together with other aspects of the prior art, including those teachings useful in light of the present invention, are disclosed more fully and better understood in light of the following references, each of which is incorporated herein in its entirety.
[1] N. Gisin, G. Ribordy, W, Tittel, and H. Zbinden, “Quantum cryptography,” Reviews of Modern Physics, vol. 74, pp. 145-195, 2002.
[2] G. Barbosa, E. Corndorf, P. Kumar, H. Yuen, “Secure communication using mesoscopic coherent states,” Physics Review Letters, vol. 90, 2003,
[3] E. Corndorf, G. Barbosa, C. Liang, H. Yuen, and P. Kumar, “High-speed data encryption over 25 km of fiber by two-mode; coherent-state quantum cryptography,” Optics Letters, vol. 28, pp. 2040-2042, 2003.
[4] E. Selmer, Linear Recurrence over Finite Field, Norway; University Of Bergen, 1996.
[5] N. Zierler and J, Brillhart, “On primitive trinomials (mod 2).” Journal of Information and Control, vol. 15, pp. 541-544. 1968.
[6] C. Helstrom, Quantum Detection and Estimation Theory, New York; Academic, 1976.
[7] E. Corndorf, G. S. Kanter, C. Liang, and P. Kumar, “Quantum-noise protected data encryption for WDM networks,” presented at the Conference on Lasers and Electro-Optics (CLEO'2004), San Francisco, Calif., May 16-21, 2004; paper CPDD8.
[8] E. Corndorf, C. Liang, G. S. Kanter, P. Kumar, and H. P. Yuen, “Quantum-noise-protected data encryption for WDM fiber-optic networks,” ACM Computer Communication Review: Special Section on Impact of Quantum Technologies on Networks and Networking Research, Vol. 28, October 2004.

### SUMMARY OF THE INVENTION

The disadvantages and limitations of the background art discussed above are overcome by the present invention. With this invention, there is provided a quantum cryptographic protocol using two-mode coherent states that is optically amplifiable, resulting in a polarization independent system that is compatible with the existing WDM infrastructure. The method and system provide secure data encryption suitable for wavelength division multiplexing networks through an in-line amplified line.

The present invention provides a method for transmitting encrypted data from a first location to a second location over a communication link that includes a plurality of transmission channels over which a plurality of independent channels of data traffic flow simultaneously, wherein unencrypted data is transmitted over a plurality of the transmission channels transmit. The method includes encrypting a light wave with data to be transmitted; coupling the encrypted light wave onto one of the transmission channels of the communication link at the first location; transmitting the encrypted light wave to the second location over the communication channel; and decrypting the encrypted light wave at the second location to recover the transmitted data. The communication link can include a free-space portion or a fiber-optic wavelength division multiplexing network. The encrypted light wave can be multiplexed onto the transmission channel that is carrying a conventional unencrypted information bearing light wave for transmission over the transmission channel. The encrypted light wave and the unencrypted information bearing light wave can be transmitted at different data rates over the transmission channel. The encrypted light wave can be amplified while the encrypted light wave is being transmitted from the first location to the second location, including being amplified at the first and/or second locations. The method can be implemented over all types of networks, including enterprise, metro, short haul, and long haul networks, and independent of underlying software protocols.

Further in accordance with the present invention, there is provided a method and system for transmitting data from a first location to a second location over a communication channel. In accordance with the invention a shared multi-bit secret key K is extended at the transmitting and receiving locations to produce an extended key K′. The extended key K′ is mapped to a function to produce a mapped extended key K″ that is used at the transmitting location, along with the bits of the binary bit sequence to be transmitted, to select a quantum state for each bit to be transmitted to the receiving location. A light wave is modulated with the selected quantum states for transmission to the receiving location over an all optical channel. At the receiving location, using the mapped extended key K″, the modulated light wave transmitted over optical channel is subjected to an all-optical rotation to a state corresponding to the mapped extended key K″, effectively decrypting the optical signal. The signal is demodulated to recover the binary bit sequence, and the binary bit sequence is decoded to recover the binary bit sequence transmitted.

When operating in polarization mode, the bases correspond to orthogonal pairs of polarization-states and decoding includes flipping each received data bit as a function of the mapped extended key. When operating in the time mode, the bases correspond to antipodal phase-states and decoding includes differentially flipping each received data bit as a function of the mapped extended key.

The system of the present invention is of a construction which is both durable and long lasting, and which will require little or no maintenance to be provided by the user throughout its operating lifetime. The system of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a graph illustrating a numerical calculation of Eve's maximum information acquired via an optimal individual ciphertext-only attack on a message for values of M=1001 and M=2047;

FIG. 2 illustrates a plurality of pairs of orthogonal states uniformly spanning a great circle of the Poincare sphere in an embodiment employing polarization mode operation;

FIG. 3 illustrates a plurality of pairs of orthogonal phase states uniformly spanning a phase circle in an embodiment employing time mode operation;

FIG. 4 is a process flow chart for quantum-noise protected data encryption schemes provided by the present invention;

FIG. 5 is a schematic of a quantum data encryption/decryption system using polarization states in an all-optical network in accordance with the invention;

FIG. 6 is a schematic of one example of a WDM network including a link over which travels the encrypted data produced by the system of FIG. 5;

FIG. 7 is a graph showing the optical spectrum after a first arrayed waveguide grating in the fiber link of the WDM network of FIG. 6;

FIG. 8 is an Eye diagram of a pseudo-random bit sequence channel at the start of a WDM fiber link of the WDM network of FIG. 6;

FIG. 9 is a graph showing the optical spectrum at the end of the WDM fiber link of the WDM network of FIG. 6;

FIG. 10 is an Eye diagram of a pseudo-random bit sequence channel at the end of the 100 km WDM fiber link of the WDM network of FIG. 6;

FIG. 11 shows a sequence of bits corresponding to a digital photo of an American flag transmitted from Alice to Bob using the quantum data encryption/decryption system of FIG. 5;

FIG. 12 shows the same sequence of the bits shown in FIG. 11, but as seen by the attacker, Eve;

FIG. 13 is a simplified representation of a polarization independent receiver for use in decryption and demodulation of AlphaEta M-ry time mode encrypted signals in accordance with the present invention;

FIGS. 13a-13d are simplified representations of other polarization independent receivers that are similar to the polarization independent receiver of FIG. 13; and

FIG. 14 is a schematic of a realization of a quantum data encryption/decryption system incorporating the receiver of FIG. 13.

### DETAILED DESCRIPTION OF THE PREFERRED EMBODIMENTS

The present invention provides a quantum cryptographic protocol using two-mode coherent states that is optically amplifiable, resulting in a polarization independent implementation that is compatible with the existing WDM infrastructure, and an alternative implementation using polarization states that is particularly suited for free-space applications. Note that either implementation is applicable to both free-space and fiber-optic WDM networks. The present invention provides secure data encryption suitable for wavelength division multiplexing networks through an in-line amplified line. According to the present invention, any number of channels of a transparent WDM network, either in optical fiber or in free space, can be encrypted between two end points and such encrypted communication can be multiplexed with conventional unecrypted communication. The encrypted and unencrypted channels can be at different data rates and can simultaneously pass through optical amplifiers, optical multiplexers and demultiplexers including reconfigurable optical add/drop multiplexers, and any number of other optical networking elements that are used in present day optical communication and networking infrastructure. The encryption methods described in this invention can be implemented over all types of networks, including enterprise, metro, short haul, and long haul, and are independent of underlying software protocols. Furthermore, the time-mode scheme described below can be implemented on an optically amplified fiber line using erbium, Raman, semiconductor, parametric, or any other optical amplifier in use today.

Coherent-State Data Encryption: Polarization Implementation

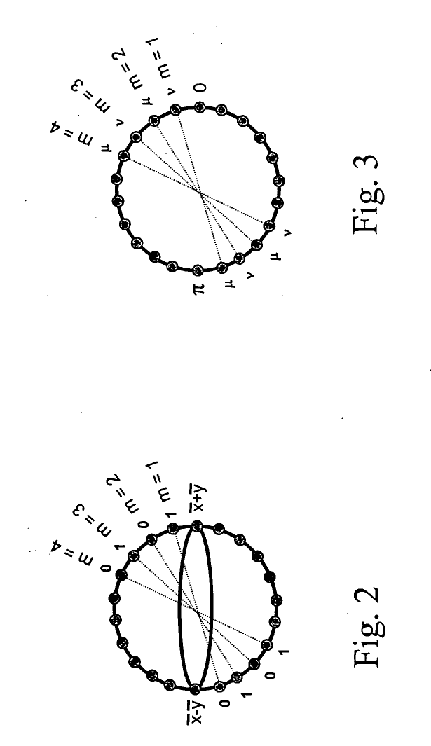

We discuss first the polarization mode implementation. The time mode implementation is described starting at paragraph [0062]. The irreducible measurement uncertainty of two-mode coherent states is the key element in the security of applicants' scheme. The two-mode coherent states (polarization states) employed in this scheme are
|ψₘ^{(a)}>=|α>_{I}\mathring{×}|αe^{iθ}>_{y}, (1)
|ψₘ^{(b)}>=|α>ᵣ\mathring{×}|αe^{i(θ}^{ₘ₊₎}>_{y}, (2)
where θₘ=πm/M, mε{0, 1, 2, . . . (M−1)}, and M is odd. Viewed on the Poincaré sphere, these 2 M polarization states form M bases that uniformly span a great circle as shown in FIGS. 2 and 3. Using a publicly known key extension algorithm, for example, an s-bit linear feedback shift-register (LSFR) with judiciously chosen feedback terms, the transmitter (Alice) extends an s-bit secret-key, K, to a (2^{s}−1) bit extended key, K′, which is then deterministically mapped on to (1-to-1) different 10-bit sequences producing a mapped, extended key K″. The extended and mapped key K″ is grouped into disjointed blocks of r-bit running keys, R, where r=log₂ (M) and s>>r. Depending on the data bit and the running-key R, the state in equation (1) or equation (2) is transmitted, where m is the decimal representation of R and the data bits are defined differentially. Specifically, if m is even, then (0,1)→(|ψₘ^{(a)}>, |ψₘ^{(b)}>) , and if m is odd, then (0,1)→(|ψₘ^{(b)}>, |ψₘ^{(a)}>). Stated in another way, logical zero is mapped to (|ψₘ^{(a)}> |ψₘ^{(b)}>) if the previously transmitted state was from the set (|ψₘ^{(a)}> |ψₘ^{(b)}>) and logical one is mapped to (|ψₘ^{(b)}> |ψₘ^{(a)}>) if the previously transmitted state was from the set (|ψₘ^{(b)}> |ψₘ^{(a)}>). This results in the mapping of the symbols on the phase circle to be interleaved 0,1,0,1, . . . , as shown in FIG. 2.

Using the same s-bit secret-key and LFSR, the intended receiver (Bob) applies unitary transformations to his received polarization states according to the running-keys. These transformations (polarization rotations) decrypt the received states resulting in either |ηα>ₓ|ηα>_{y} or |ηα>ₓ|−ηα>_{y} depending on the logical bit where η is the channel transmissivity. Bob then further rotates the states by π/4 so that the states under measurement are given by equations (3) and (4) as follows:
|ψₘ^{(a)}> [symbol] =|\sqrt{2}ηα>_{I}\mathring{×}|0>_{y}, (3)
|ψₘ^{(b)}> [symbol] =|0>_{I}\mathring{×}|−\sqrt{2}ηα>_{y}, (4)
where η is the channel transmissivity. Equations (3) and (4) make up a two-mode, on-off-key signal set, where the logical mapping corresponds to the parity of the running-key, R. The decrypted, logically encoded states are then detected using two-mode difference photodetection.

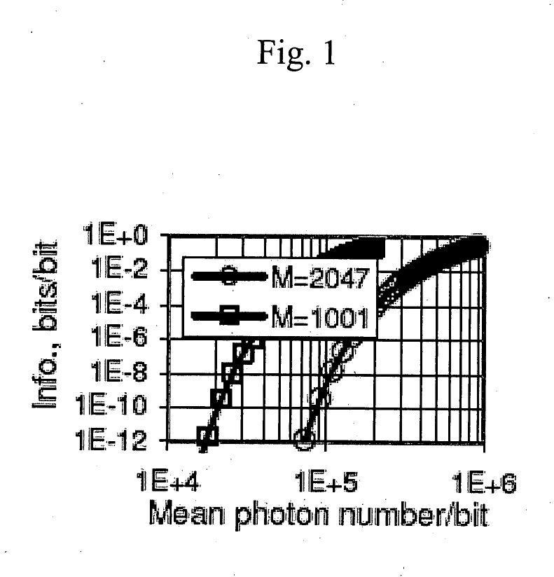

Without knowledge of the secret-key and lacking the plain-text, an eavesdropper (Eve) is unable to decrypt Alice's transmission, even when granted ideal detection equipment and all of the transmitted energy. Individual ciphertext-only attacks on the message are thwarted by the irreducible measurement uncertainty of two-mode coherent states. An attack on the message requires Eve to distinguish neighboring polarization states due to the interleaving of the logical bit mappings (FIG. 2). A calculation of Eve's optimal quantum measurement shows that her information per bit I asymptotically approaches ½ as |α| is decreased for a given value for M, as shown in FIG. 1. The inability to distinguish neighboring polarization states also assures computational security of the secret-key, even if Eve possesses a quantum computer, by forcing the search space of possible LFSR states to be exponential in “s”. With the addition of classical randomization at the transmitter, the scheme provides information theoretic security for the secret-key against a ciphertext-only attack.

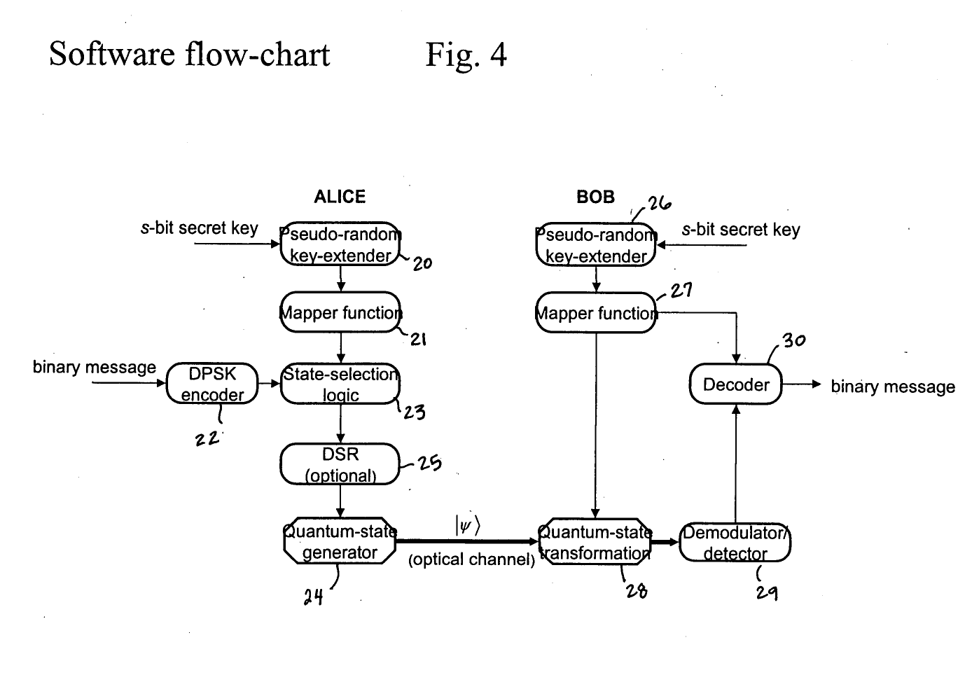

Referring to FIG. 4, there is illustrated a flow chart of the quantum-noise protected data encryption scheme for both polarization- and time-mode in accordance with the present invention. The following is a description of the flow chart.

The users (Alice and Bob) use a deterministic extension-algorithm, respective blocks 20 and 26, to extend a shared s-bit secret-key known only to them. Such algorithms may include linear-feedback shift-registers, or existing stream-ciphers. The extended key, now much longer than the s-bit secret-key, then undergoes a deterministic transformation known as “mapping”, respective blocks 21 and 27. The purpose of this transformation is to spread the errors that an attacker eventually makes when estimating the running keys across the entire extended key are not focused on just a few bits of each running key. An example of such a “mapping function” would be to deterministically map (1-to-1) 10-bit non-overlapping blocks of the extended key to different 10-bit sequences. Further details as to expansion of secret keys for use in quantum encryption/decryption schemes is described in U.S. application Ser. No. 10/674,241, which was filed on Sep. 29, 2003, which is assigned to the same assignee as the present application.

Alice then uses her mapped extended-key K″, along with the data bit sequence to be transmitted, encoded by a DPSK encoder function, block 22, used only in the time-mode scheme, to select a quantum-state to be generated. In contrast to the polarization-mode scheme, the logical bits in the time-mode scheme are defined differentially. The encoding rule is the following: given a sequence of bits X to be differentially encoded into a sequence of bits Y, Yₙ=XOR(Xₙ, Xₙ₋₁). For example, a data sequence 1001010 would be encoded as 010111. Specifically, consecutive, non-overlapping groups of the extended key (called running keys) are used to select a “basis” on which to encode the data bit, block 23. These bases correspond to orthogonal pairs of polarization-states in the polarization-mode scheme and antipodal phase-states in the time mode scheme; see FIG. 3. Depending on the logical bit to be transmitted (0 or 1), one of the two states that make up a basis is chosen for generation and transmission, block 24. This mapping of data bits onto polarization or phase-states is done in a geometrically interleaved way 0,1,0,1,0,1 . . . as shown in FIG. 3. Optionally, before entering the quantum-state generator, the chosen state to be transmitted can undergo another permutation known as deliberate state randomization (DSR), block 25. The deliberate state randomization can be carried out by an analog or digital truly random or pseudo random number generator. Under DSR, the selected state to be generated and transmitted undergoes a randomization known only to Alice. This randomization will result in the actual state that is generated to be within ±θ that is less than or equal π/2 (on the “circle”) with respect to the pre-DSRed state (FIG. 3). The magnitude of such θ value is an adjustable parameter which controls the level of security in the AlphaEta scheme. After the optional step of DSR, the chosen state to be transmitted is sent to the quantum-state generator for optical-state encoding for transmission over an optical channel to the receiving location (Bob).

On receiving the quantum-state transmission, the receiver (Bob) uses his mapped, extended-key to apply an all-optical rotation to the state corresponding to his mapped, extended-key (which is the same as Alice's). This rotation effectively decrypts the optical signal, block 28. The optical signal then enters an optical demodulator/detector, block 29, where the optical signal is converted into an electrical signal and a bit decision is made and the detected bits are passed to a post-coder function, block 30.

Digressing, before a description of the post-coder function can be given, a little more information on the encoding process is required. At the transmitter (Alice) sufficient electrical voltage (power) is required to be able to generate all of the possible quantum-states in either the polarization-mode or time-mode schemes by driving optical phase-modulators. In the time-mode scheme, this corresponds to a phase modulation from 0 to 2π radians and in the polarization-mode scheme, this corresponds to a full “great circle” polarization-state rotation. In either 30 case, the corresponding voltages required are 0 to 2 V_{π} volts where V_{π} is a characteristic voltage of the phase modulator.

On the receiving end (Bob), the need to rotate the phase or polarization-state of the incoming signal, which corresponds to a drive voltage of 0 to 2 V_{π} volts, is still present in order to properly decrypt the arriving optical signal. The post-coder function, block 30, helps to alleviate the voltage (power) requirements on Bob's phase modulator(s) by introducing a coding scheme whereby the voltage required to drive Bob's phase modulator(s) is cut in half from 0 to 2 V_{π} volts to 0 to V_{π} volts.

In the polarization-mode scheme, the post-coder function, block 30, simply corresponds to “flipping” each received data bit as a function of the mapped extended-key. Specifically, if the last bit of a running key corresponding to a particular data bit were 0, then nothing should be done to the data bit. If, on the other hand, the last bit of a running key corresponding to a particular data bit were 1, then the data bit should be flipped.

In the time-mode scheme, the post-coder function, block 30, is slightly more complicated that in the polarization-mode scheme. A similar flipping of data bits is required as a function of the last bit of each running key with an addition. Due to the fact that the data bits are differentially encoded at the transmitter, the post-coder function, block 30, requires a “differential flipping rule” which essentially states that if the two consecutive data bits “need” to be flipped according to the last bit of the running key, then flip the first bit, don't flip the second bit, and flip the third bit. The same rule applies for n consecutive bits that “need” to be flipped; flip the first bit, don't flip the next (n−1) bits, and flip the (n+1) bit.

Again, the purpose of the post-coder function, block 30, is simply to reduce the voltage (power) required to drive the phase modulator(s) at the receiver and to improve the quality of the transitions in the received signal. This technique cannot be used at the transmitter (Alice).

Experimental Setup of the Polarization Implementation

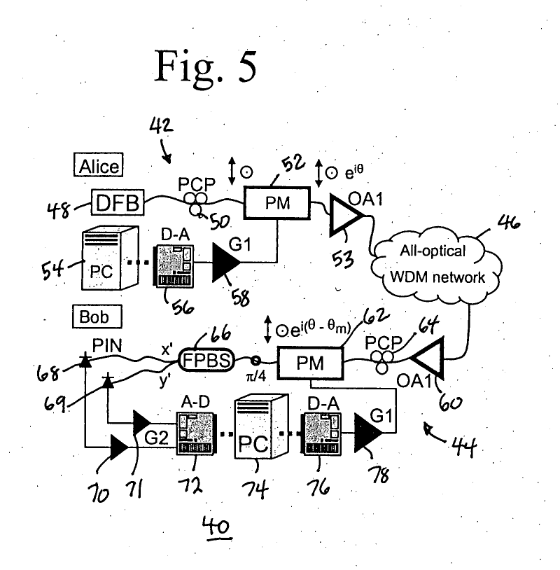

FIG. 5 is a schematic of a quantum data encryption/decryption system 40 in accordance with the invention, including a quantum data-encryption transmitter 42 coupled to a receiver 44 over an all-optical network, such as a wavelength division multiplexing (WDM) network 46 over which the encrypted data travels.

The transmitter (Alice) 42 includes a laser 48, a polarization-control-paddle (PCP) 50, a phase modulator 52 and an optical amplifier 53. The transmitter further includes an extended key generator which can be implemented by a personal computer (PC) 54, or alternatively by a microprocessor embedded in an field-programmable gate array. The output of the PC 54 is coupled through a digital-to-analog (D/A) converter 56 and an amplifier 58 to the phase modulator 52.

The laser 50 can be a distributed-feedback (DFB) laser. The phase modulator 52 can be a 10 GHz-bandwidth fiber-coupled LiNbO3 phase modulator that is driven by the output of the D/A converter 56 amplified by the amplifier 58. The output of the phase modulator 52 is coupled to an all optical network through the optical amplifier 53. The D/A converter 56, which can be a 12-bit digital-to-analog converter, introduces a relative phase (0 to 2π radians) between the two polarization modes. The extended key generator can be a linear feedback shift register (LFSR) implemented in software on a personal computer (PC) 56, or alternatively by a microprocessor embedded in an field-programmable gate array.

The receiver (Bob) 44 includes an optical wave amplifier 60, a phase modulator 62, a second PCP 64, and a polarizing beam splitter 66. In addition, the receiver includes a pair of detectors 68 and 69 having associated amplifiers 70 and 71, respectively, and an analog to digital converter (A/D) 72, which is interposed between the outputs of the amplifiers 70 and 71 and a personal computer (PC) 74. The receiver 44 further includes a digital to analog converter (D/A) 76 and an electrical signal amplifier 78 through which the output of the PC 74 is applied to the phase modulator 62.

The optical wave amplifier 60 can be an erbium-doped fiber amplifier (EDFA) having approximately 30 dB of small signal gain and a noise figure very close to the quantum limit (NF≅3 dB). The phase modulator 62 can be a LiNbO3 phase modulator. The PCP 64 is interposed between the optical wave amplifier 60 and the phase modulator 62 for canceling the polarization rotation caused by the fiber in an optical fiber communication link of the WDM network 46 over which the encrypted data is transmitted from the transmitter 42 to the receiver 44. The beam splitter 66 can be a fiber-coupled polarization beam splitter (FPBS) oriented at π/4 radians with respect to the principal axes of the phase modulator 62. The extended key generated by the software implemented LFSR in the PC 74 is applied via the D/A converter 76 and amplifier 78 to the phase modulator 62. The detectors 68 and 69 can be 1 GHz-bandwidth InGaAs PIN photodiodes. The electrical signal amplifiers 70 and 71 can be 40 dB-gain amplifiers.

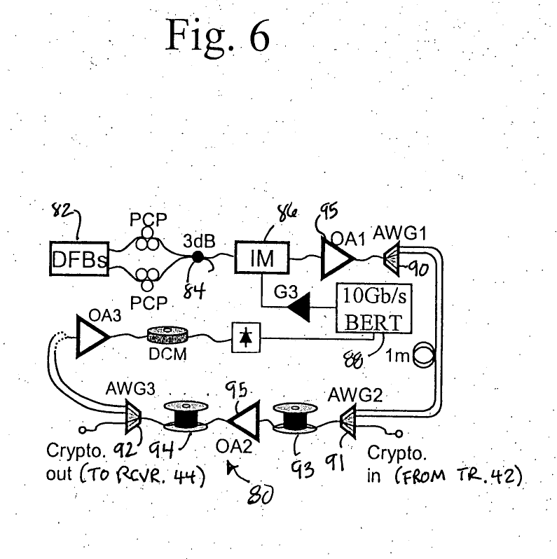

Referring now to FIG. 6, there is shown a schematic of a WDM network which can implement the WDM network 46 of FIG. 6, effectively simulating random, real-world data traffic. The WDM network 46 includes a WDM link 80 representing a portion of the WDM network 46 over which the encrypted data produced by the system 40 of FIG. 5 travels. Along with the quantum-noise encrypted data, classical data traffic also propagates through the described WDM link 80. For simulating other “data traffic”, light from two DFB lasers 82 on the 100 GHZ ITU grid (1546.9 nm and 1553.3 nm) is mixed on a 3 dB coupler 84 where one output is terminated and the other enters a 10 GHz-bandwidth fiber-coupled LiNbO3 intensity modulator (Mach-Zender) 86. The intensity modulator 86 is driven by the amplified output of a 10 Gbps pseudo-random bit sequence (PRBS) generated by a 10 Gbps pattern generator/BERT 88 with PRBS period 2³¹−1 bits. The PRBS modulated ITU grid channels (hereafter referred to as the PRBS channels) then pass through an EDFA amplifier 95 to compensate for losses before entering, and being spectrally separated by, an arrayed-waveguide grating (AWG) 90. By introducing a one meter fiber length difference between the separated PRBS channels before launching them into the 100 km WDM link 80. As shown in FIG. 6, the 100 km WDM link 80 consists of two 100 GHz-spacing 40-channel arrayed-waveguide gratings (AWG) 91 and 92, two 50 km spools of single-mode fiber (such as Corning SMF-28e type fiber) 93 and 94, and an in-line amplifier (EDFA) 95 with an output isolator. The amplified, group-velocity-dispersion compensated PRBS channel is detected using an InGaAs PIN-TIA receiver 98 and measured by the 100 Gbps BERT 88.

Referring again to FIG. 5, in operation, the polarization-control-paddle (PCP) 50 is adjusted to project the light from the DFB laser 48 equally into the two polarization modes of Alice's fiber-coupled phase modulator 52. The phase modulator 52 is driven by the amplified output of the digital-to-analog converter 56 to introduce a relative phase between the two polarization modes. By way of example, the phase can be 0 to 2π radians. The software-implemented LFSR yields a running-key, that when combined with a data bit, instructs the generation or one of the two states in accordance with equation (1) or (2).

On passing through the WDM link 80 of the WDM network 46, from an input Crypto. In at AWG 91 and to an output Crypto. Out at AWG 92, the light is amplified by the optical wave amplifier 95. From the output Crypto. Out, before passing through Bob's phase modulator 62, the received light is sent through the PCP 64 to cancel the polarization rotation caused by the fiber in the WDM link 80. While these rotations fluctuate with a bandwidth on the order of kilohertz, the magnitude of the fluctuations drops quickly with frequency, allowing the use of a manual PCP to cancel the unwanted polarizations. In other implementations, Bob's measurements can be used to drive an automated feedback control on the PCP.

The relative phase shift introduced by the phase modulator 62 is determined by the running-key R generated through the software LFSR in Bob's PC 74 and applied via the output of the D/A converter 76 amplified by amplifier 78. After this phase shift has been applied, the relative phase between the two polarization modes is 0 or π, corresponding to a 0 or 1 according to the- running-key: if R is even, then (0, π)→(0, 1) and if R is odd, then (0, π)→(1, 0). With use of a fiber-coupled polarization beam splitter (FPBS) 66 oriented at π/4 radians with respect to the principal axes of the phase modulator 62, the state under measurement [equations (3) or (4)] is direct-detected by using two photodiodes operating at room temperature, one for each of the two polarization modes. The resulting photocurrents from photodiodes 68 and 69 are amplified by respective electrical signal amplifiers 70 and 71, sampled by the analog-to-digital (A-D) converter 72, and stored for analysis. The overall sensitivity of Bob's preamplified receiver was measured to be 660 photons/bit for 10⁻⁹ error probability.

On propagating through the WDM link 80 (FIG. 6), one of the two PRBS channels is amplified with a 20 dB gain EDFA 95 (operating in the linear regime) and group-velocity-dispersion compensated −1530 ps/nm using a dispersion compensation module (DCM). While the group velocity dispersion introduced by the 100 km WDM link 80 is approximately 1700 ps/nm, but can be other value. The amplified, group-velocity-dispersion compensated PRBS channel is detected using an InGaAs PIN-TIA receiver and measured by the 100 Gbps BERT. Bit error rates for each of the PRBS channels are measured separately using the BERT.

The 100 km WDM link 80 is loss compensated by the in-line EDFA 95. The 10 dB power loss of the first 50 km spool of fiber 93 (0.2 dB loss per kilometer) is compensated for by 10 dB of saturated gain from the in-line EDFA 95. The overall loss of the WDM link 80 is therefore 15 db where 10 dB come from the second 50 km spool of fiber 94 and the remaining 5 dB come from the two AWGs 91, 92; 2.5 dB of loss each.

Experimental Results from the Polarization Implementation

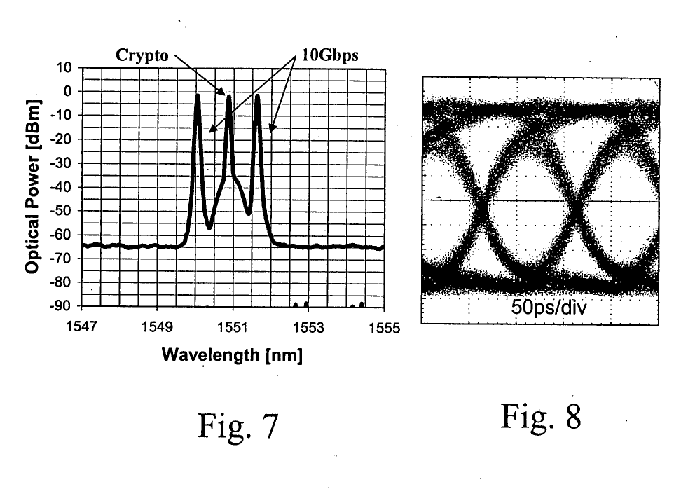

Experiments have successfully demonstrated quantum data-encryption through a data bearing 100 km WDM link using the encryption/decryption system including the transmitter/receiver pair of FIG. 5 coupled together by the WDM link 80 in FIG. 6. The experiments have also demonstrated that in the 100 km WDM link, the quantum encrypted channel does not negatively impact the data bearing channels. FIG. 7 shows the optical spectrum of the 100 km WDM link after the first AWG acquired with a 0.01 nm resolution bandwidth. The launch power in the quantum encrypted channel is −25 dBm and the launch power in each of the PRBS channels, located four 100 GHz ITU grid channels away from the encrypted channel, is 2 dBm. An eye diagram of the 1546.9 nm PRBS channel at launch is shown in FIG. 8. Measuring after the first AWG in the 100 km WDM link, neither PRBS channel showed any bit errors in 10 terabits communicated.

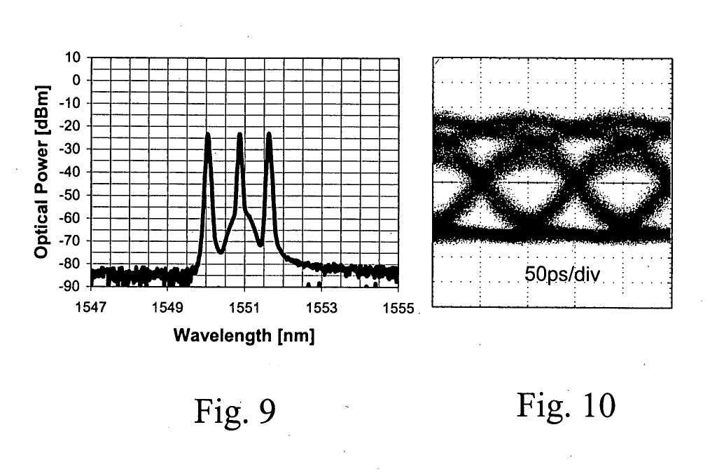

FIG. 9 shows the optical spectrum (0.01 nm resolution bandwidth) after the second 50 km spool of fiber 94 in the 100 km WDM link 80. FIG. 9 clearly shows both 10 dB of loss in the signals as well as a 10 db increase in the amplified-spontaneous-emission dominated noise floor. An eye diagram of the 1546.9 nm PRBS channel, post dispersion compensation, is shown in FIG. 10. While some group-velocity-dispersion is clearly visible in the eye diagram, the bit-error rate for each of the PRBS channels is “error free” at only 5e-11. Both the bit-error rates and eye diagrams of the PRBS channels did not change when the quantum encrypted channel was turned off.

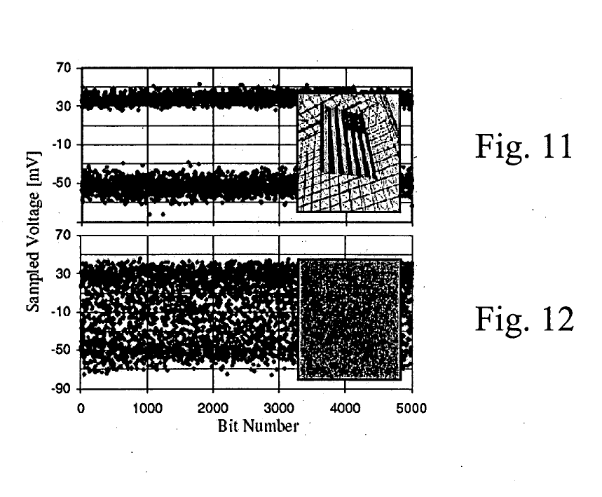

FIG. 11 shows results from 5000 A-D measurements (one of the two polarization modes) of a 9.1 Mb bitmap file transmitted from Alice to Bob, shown in the top portion of FIG. 11, and to Eve, shown in the bottom portion of FIG. 11, through the 100 km WDM link. The data rate is 250 Mbps. The insets show the respective decoded images. In this experiment, actions of Eve are physically simulated by Bob starting with an incorrect secret-key. Clearly, a real eavesdropper would aim to make better measurements by placing herself close to Alice and implementing the optimal quantum measurement. While FIG. 11 does not explicitly demonstrate Eve's inability to distinguish neighboring polarization states, it does, however, show that a simple bit decision is impossible. In one experiment that was conducted, the 12-bit D-A conversion allows Alice to generate and transmit 4094 distinct polarization states (M=2047 bases). The numerical calculation used to plot FIG. 1 (left side) then shows that for −25 dBm launch power at 250 Mbps and M=2047, Eve's maximum obtainable information in an attack on the message is less than 1e-12 bits/bit. Note, however, that because of the use of a short secret-key (32-bits), the security of this particular demonstration is weak against attacks on the secret-key through exhaustive search.

Coherent-State Data Encryption: Time-Mode Implementation—Polarization Independent Decryptor Compatible With Standard NRZ and RZ Communication Formats

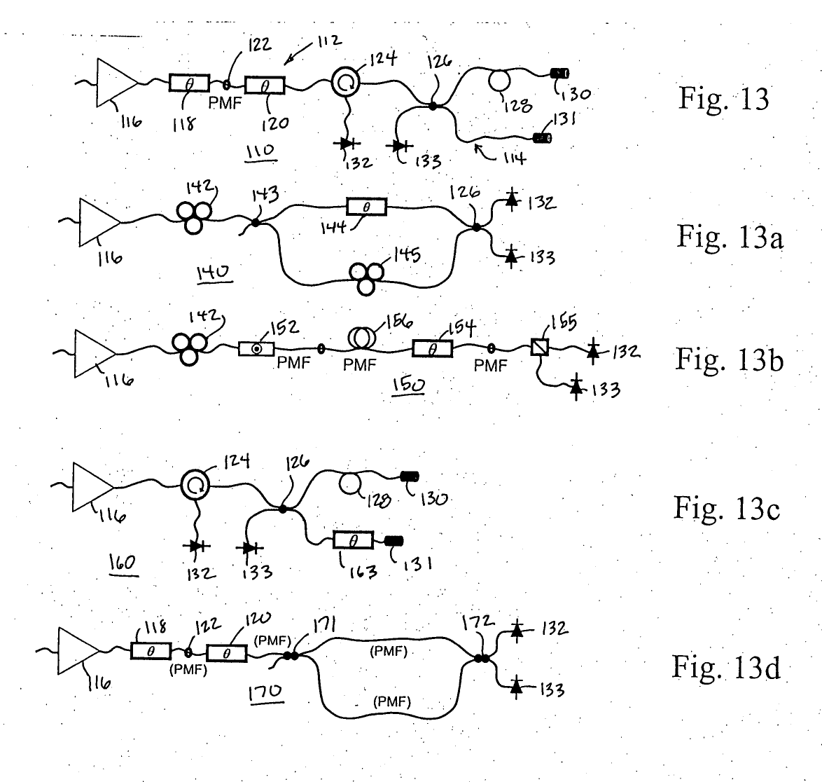

FIG. 13 is a simplified representation of a receiver 110 for use in the decryption and demodulation of AlphaEta M-ry two-mode (time-mode) encrypted signals. The receiver 110 is a totally polarization-independent M-ry decryptor 112 followed by a totally polarization-independent two-mode (time-mode) demodulator 114. The M-ry decryptor 112 is compatible with both standard non-return to zero (NRZ) and return to zero (RZ) communication formats. The receiver 110 is totally polarization insensitive. The receiver 110 includes phase stabilization.

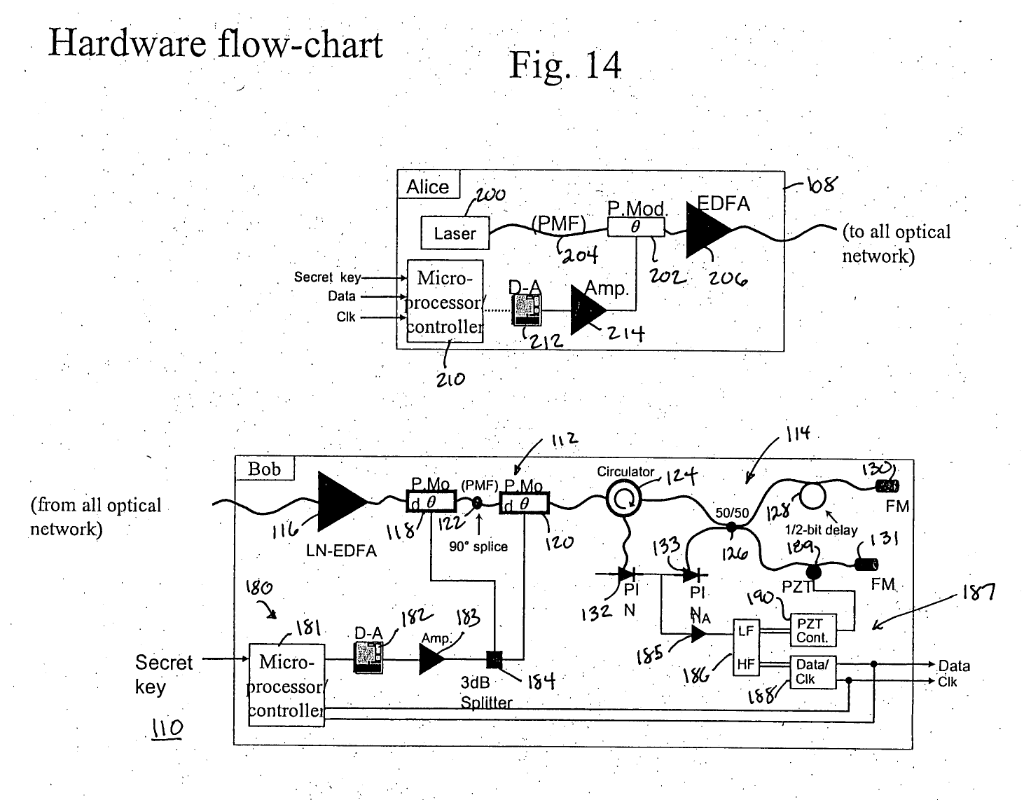

More specifically, with reference to FIG. 13, only optical components of the receiver 110 are shown for the simplified representation of the receiver 110. The receiver 110 includes an optical amplifier 116, a pair of concatenated optical phase-modulators 118 and 120 that are connected with polarization-maintaining fiber 122 and oriented with a 90° rotation, so that the two polarization-modes of the optical signal receive the same amount of optical phase-modulation, thereby making the process of decryption insensitive to the polarization-state of the incoming light. The demodulator 114 includes an optical circulator 124 and a fiber Michelson interferometer formed by a 50/50 optical coupler 126 and two Faraday mirrors (FM) 130 and 131. A path length difference is provided by a fiber loop 128 in one of the arms. The path length difference in the arms of the interferometer corresponds to the period of an optical symbol (bit). The receiver 110 includes a detector including two PIN photodiodes 132 and 133. The operation of the receiver 110 is described below with reference to FIG. 14.

The receiver 140 shown in FIG. 13a is similar to the receivers that are described with reference to FIGS. 18 and 27 in U.S. application Ser. No. 10/674,241, which was filed on Sep. 29, 2003. The receiver 140, only optical components of which are shown, includes an optical amplifier 116 and asymmetric optical path lengths, including a long arm and a short arm, the long arm including an optical phase-modulator 144 and the short including a polarization-control-paddle (PCP) 145. The receiver 140 includes a detector formed by two photodiodes 132 and 133.

The receiver 140 produces sub-bit period twin pulses which are not in the NRZ format. The receiver 140 is externally and internally polarization sensitive. In addition, the receiver 140 requires an exotic detection timing and requires stabilization of the interferometer.

The receivers 150, 160 and 170, shown in FIGS. 13b, 13c and 13d, respectively, represent receiver designs intermediate the receiver 110 shown in FIG. 13 and the receiver 140 shown in FIG. 13a, depicting the evolution of the receiver 110 shown in FIG. 13. The receiver 150, only optical components of which are shown, includes phase modulators 152 and 154 separated by a length of polarization maintaining fiber (PMF) 156. The receiver 150 produces twin pico-second pulses which are not in the NRZ format. The receiver 150 is externally and internally polarization sensitive. In addition, the receiver 150 requires an exotic detection timing.

The receiver 160 is totally polarization insensitive. The receiver 160, only optical components of which are shown, includes an optical circulator 124 and a fiber Michelson interferometer, formed by an optical coupler 126 and two Faraday mirrors 130 and 131 in the manner of receiver 110. In addition, the receiver 160 requires phase stabilization.

The receiver 170, only optical components of which are shown, includes a pair of concatenated optical phase-modulators 118 and 120 that are connected with polarization-maintaining fiber 122 and oriented with a 90° rotation. Consequently, the two polarization-modes of the optical signal receive the same amount of optical phase-modulation, thereby making the process of decryption insensitive to the polarization-state of the incoming light. The receiver 170 produces 50/50 duty cycle pulses in an NRZ format with the bit rate limited by the bandwidth of the modulator. The receiver 170 includes phase stabilization.

The receivers 150, 160 and 170, shown in FIGS. 13b-13d, are feasible. However, the receiver 110 shown in FIG. 13 has several practical advantages and is compatible with standard NRZ and RZ communication formats being used with WDM communications today.

FIG. 14 is a detailed schematic of a time-mode implementation including a transmitter 108 and the receiver 110 shown in FIG. 13 and the surrounding functions, and accordingly like components have been given the same reference numbers. The detailed schematic of FIG. 14 includes optical as well as electronic elements of the decryption/demodulation receiver 110. The transmitter 108 includes a laser 200, coupled to a phase modulator 202 by a length of polarization-maintaining fiber (PMF) 204. The output of the phase modulator 202 is coupled to an all optical network through an optical amplifier 206. The phase modulator 202 is driven by an electrical drive signal produced by a microprocessor 210, the output of which is coupled to the phase modulator 202 through a digital-to-analog converter 212 and an amplifier 214. Inputs to the microprocessor 210 include the secret key, the data bits to be encrypted and a clock signal for synchronization.

More specifically, the phase modulator 202 can be a lithium niobate phase modulator. The optical phase of the light is changed by the phase modulator 202 in response to the drive signal applied to the phase modulator 202. The drive signal, consisting of differential-phase-shift-keyed data-bit information as well as an encryption signal, is the amplified output of a digital-to-analog converter 212 that is driven by a micro-processor/micro-controller 210.

As described above, the receiver 110 is a totally polarization-independent M-ry decryptor 112 followed by a totally polarization-independent two-mode (time-mode) demodulator 114. The M-ry decryptor 112 is compatible with both standard non-return to zero (NRZ) and return to zero (RZ) communication formats. The receiver 110 includes an optical amplifier 116, a pair of concatenated optical phase-modulators 118,120 that are connected with polarization-maintaining fiber 122 and oriented with a 90° rotation, so that the two polarization-modes of the optical signal receive the same amount of optical phase-modulation, thereby making the process of decryption insensitive to the polarization-state of the incoming light. The receiver 110 includes a demodulator 114 formed by an optical circulator 124 and a fiber Michelson interferometer. The interferometer includes a 50/50 optical splitter 126 and two Faraday-rotator mirrors (FM) 130 and 131. A path length difference is provided by a fiber loop 128 in one of the arms. The path length difference in the arms of the interferometer corresponds to the period of an optical symbol (bit). The detector of the receiver 110 includes two photodiodes 132 and 133. The design of the demodulator is chosen to maintain polarization insensitivity using fiber-based components. Other demodulators, such as asymmetric Mach-Zehnder interferometers integrated on an, optical substrate, can also be used.

The Michelson interferometer operates as a dither-lock-stabilized interferometer that “decodes” the data bits which are differentially encoded into their original un-encoded form. The arms of the interferometer are set to be 1/2 bit-period off from one another in length (1 bit-period round trip), allowing the differentially encoded optical signal to be demodulated, resulting in two outputs from the interferometer. The outputs of the interferometer are detected by the photodiodes 132 and 133 oriented in a “differencing” mode. The differencing mode is strictly not needed, but can improve performance in some cases. Because the interferometer uses faraday-rotator mirrors rather than plain mirrors, the interferometer is made polarization-state independent. That is to say that the interferometer performance is not a function of the polarization-state of the light entering the interferometer.

The electrical components of the receiver 110 include an electrical decrypting signal generator 180 including a microprocessor controller 181, a digital-to-analog converter D/A 182, an amplifier 183 and a splitter 184. The electrical components of the receiver 110 further include a trans-impedance amplifier (TIA) 185, low/high frequency component separator 186, a piezo-electric stretcher 187 and data/clock recovery circuit 188. The piezo-electric stretcher 187 includes a piezoelectric (PZT) element 189 connected in one arm of the interferometer and a PZT controller 190 coupled to the output of the low/high frequency component separator 186.

The trans-impedance amplifier (TIA) 185 is located in the circuit before the electronic high-frequency signal (bit information) is separated from the low frequency signal (dither-lock information). The low frequency signal enters a dither-locking circuit which locks the phase of the interferometer. This is achieved with the use of a piezo-electric stretcher 187 on one of the optical-fiber arms of the interferometer. The high frequency electronic signal (data bits) enters a clock/data recovery circuit 188 which electronically “recovers” the data and clock signals. These signals are driven back into the micro-processor/micro-controller 181 for the purpose of maintaining cryptographic synchronization between the two users (Alice and Bob).

The electronic voltage signal that drives the concatenated phase modulators 118 and 120 is the same signal where an electronic delay equal to the optical path-length delay between the phase modulators 118 and 120 is required. The voltage signal is the output of the digital-to-analog converter 182 that is then amplified and split into two equal parts, one for each modulator. The digital-to-analog converter 182 is driven by the output of the micro-processor/micro-controller 181. The micro-processor/micro-controller 181 of the receiver 110 is driven by the secret-key as well as with the arriving encrypted data stream for synchronization purposes.

The system of FIG. 14 is an improvement over the time-mode scheme proposed in FIGS. 18 and 27 of U.S. application Ser. No. 10/674,241. The system illustrated in FIG. 14 provides quantum-noise protected data encryption in a polarization-state insensitive manner. This differs from the polarization-mode schemes disclosed in FIGS. 6, 22, 23, 24 of U.S. application Ser. No. 10/674,241, in which data encryption is based on varying the polarization state of light.

In operation, light from the laser light source 200 is applied via a polarization-maintaining fiber 204 to the phase modulator 202 where it is encrypted by the drive signal produced by the microprocessor 210 producing an M-ry phase encrypted optical signal (RZ or NRZ modulation format) with the bit sequence to be transmitted. The phase-modulated light, amplified by optical amplifier 206 and leaves the transmitter (Alice).

On propagating through the all-optical channel, the information-bearing light signal transmitted by Alice arrives at the receiver (Bob) and is first amplified by the optical amplifier 116. The light then propagates through the pair of concatenated optical phase-modulators 118 and 120 oriented at 90° degrees with respect to each other. The purpose of these phase modulators 118 and 120 is to remove the encryption signal that was applied to the optical signal at the transmitter. The need for a pair of modulators rather than just one stems from the polarization sensitivity of the modulators used in this demonstration (Lithium niobate phase modulators). The polarization maintaining fiber 122 is used to flip the polarization modes of the optical signal before the optical signal enters the second phase modulator 120. By connecting the modulators with polarization-maintaining fiber and orienting the modulators with a 90° rotation, the two polarization-modes of the optical signal receive the same amount of optical phase-modulation thereby making the process of decryption (the process of removing the optical encryption signal) insensitive to the polarization-state of the incoming light. The uncertainty of the polarization-state of the light entering Bob is due to the fact that the all-optical channel may apply an arbitrary polarization-state rotation unknown to either user (Alice or Bob). The optical phase of the light is changed by the phase modulator by the voltage applied to the phase modulators 118 and 120.

The electrical drive signal, consisting of differential-phase-shift-keyed data-bit information as well as an encryption signals, driving the modulator pair 118 and 120 are identical. The electronic voltage signal that drives the concatenated phase modulators is the same signal where an electronic delay equal to the optical path-length delay (between the modulators) is required. The voltage signal is the output of a digital-to-analog converter that this then amplified and split into two equal parts (for each modulator). The digital-to-analog converter is driven by the output of a micro-processor/micro-controller

The optical signal then passes through the optical circulator 124 and into the fiber Michelson interferometer. The path length difference in the arms of the interferometer corresponds to the period of an optical symbol (bit). The demodulated light leaves the interferometer where it is detected by the photodiodes 132 and 133.

After optical decryption, the optical signal passes through the optical circulator 124 and is decoded by the dither-lock-stabilized interferometer into their original un-encoded form. The arms of the interferometer are 1/2 bit-period off from one another in length (1 bit-period round trip), so that the differentially encoded optical signal as demodulated results in two outputs from the interferometer. The light from these outputs is directed onto the photodiodes 132 and 133, generating a photocurrent. Because the interferometer is polarization-state independent, the interferometer performance is not a function of the polarization-state of the light entering the interferometer.

The photocurrent then enters the trans-impedance amplifier 185 before the electronic high-frequency (bit information) is separated from the low frequency (dither-lock information). The low frequency signal enters a dither-locking circuit which locks the phase of the interferometer. This is achieved with the use of the piezo-electric stretcher 187, including the PZT 189 connected in one of the optical-fiber arms of the interferometer, controlled by the PZT controller 190. The high frequency electronic signal (data bits) enters the clock/data recovery circuit 188 which electronically “recovers” the data and clock signals. These signals are fed back into the micro-processor/micro-controller 181 for the purpose of maintaining cryptographic synchronization between the two users Alice and Bob.

As is stated above, the micro-processor/micro-controller 210 in the transmitter 108 is driven with the data bits to be encrypted, a clock signal, and a secret-key. The micro-processor/micro-controller 181 in the receiver 110 is driven by the secret-key as well as synchronizing signals produced by the clock/data recovery circuit 188 in response to with the arriving encrypted data stream for synchronization purposes.

Unlike the schemes presented in FIGS. 6, 22, 23, 24 of U.S. application, Ser. No. 10/674,241, the scheme of the system shown in FIG. 14 performs exactly the same cryptographic objective but without the use of difficult to maintain polarization-states of light. The scheme shown in FIGS. 18 and 27 of U.S. application Ser. No. 10/674,241, approximate a polarization-insensitive version of the systems shown in FIGS. 6, 22, 23, 24 of the referenced application by encrypting the data bits in phase-states of light rather than polarization-states of light. However, the receiver (Bob) used in this scheme is sensitive to polarization. In contrast, the scheme illustrated in FIG. X1, provided by the present invention, not only encrypts the data bits in phase-states of light rather than polarization-states of light, but also utilizes a carefully designed receiver (Bob) that is internally polarization-state insensitive.

It may therefore be appreciated from the above detailed description of the preferred embodiment of the present invention that it provides quantum-noise protected data encryption in a polarization-state insensitive manner. The present invention provides a data encryption/decryption system that transmits encrypted data over WDM links that is compatible with standard NRZ and RZ communication formats being used with WDM communications today.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

1. A method for transmitting encrypted data from a first location to a second location over a communication link that includes a plurality of transmission channels over which a plurality of independent channels of data traffic flow simultaneously, wherein unencrypted data is transmitted over a plurality of the transmission channels transmit, said method comprising the steps of:
encrypting a light wave with data to be transmitted;
coupling the encrypted light wave onto one of said transmission channels of said communication link at said first location;
transmitting the encrypted light wave to said second location over said communication channel; and
decrypting the encrypted light wave at the second location to recover the transmitted data.

2. The method according to claim 1, wherein the communication link includes a free-space portion.

3. The method according to claim 1, wherein coupling the encrypted light wave onto said transmission channel includes multiplexing the encrypted light wave with a conventional unencrypted information bearing light wave for transmission over said transmission channel.

4. The method according to claim 3, wherein the encrypted light wave and the unencrypted information bearing light wave are transmitted at different data rates over said transmission channel.

5. The method according to claim 1, wherein the communication link includes a fiber-optic wavelength division multiplexing network.

6. The method according to claim 5, including amplifying the encrypted light wave while the encrypted light wave is being transmitted from said first location to said second location.

7. The method according to claim 5, including amplifying the encrypted light wave at said first and/or said second location.

8. The method according to claim 1, implemented over all types of networks, including enterprise, metro, short haul, and long haul networks, and independent of underlying software protocols.

9. A method for transmitting encrypted data from a first location to a second location over a wavelength division multiplexing optical transmission link that includes a plurality of in-line amplified optical fiber transmission channels over which a plurality of independent channels of data traffic flow simultaneously, wherein a plurality of the optical transmission channels transmit unencrypted data, said method comprising the steps of:
encrypting a light wave with data to be transmitted;
coupling the encrypted light wave onto one of said optical fiber transmission channels of said optical transmission link at said first location;
transmitting the encrypted light wave to said second location over said optical fiber transmission channel; and
decrypting the encrypted light wave at said second location to recover the transmitted data.

10. The method according to claim 9, wherein coupling to encrypted light wave onto said optical fiber transmission channel includes multiplexing the encrypted light wave with a conventional unencrypted information bearing light wave for transmission over said optical fiber transmission channel.

11. The method according to claim 9, wherein the encrypted light wave and the unencrypted information bearing light wave are transmitted at different data rates over said optical fiber transmission channel.

12. The method according to claim 9, including amplifying the encrypted light wave at said first and/or second location.

13. A method for transmitting data from a first location to a second location over a communication channel, said method comprising the steps of:
extending a shared multi-bit secret key K to produce an extended key;
mapping the extended key to a function to produce a mapped extended key;
using the mapped extended key and the bits of a binary bit sequence to be transmitted to select a quantum state for each bit to be transmitted to the second location;
modulating a light wave with the selected quantum states to encrypt the light wave with the binary bit sequence to be transmitted;
transmitting the modulated light wave to the second location over the communication channel; at the second location,
extending the same shared multi-bit key to produce the extended key;
mapping the extended key to a function to produce a mapped extended key;
receiving the modulated light wave transmitted over the communication channel;
applying an all-optical rotation to a state corresponding to the mapped extended key K″, effectively decrypting the light wave; and
demodulating the decrypted light wave to recover the binary bit sequence.

14. The method according to claim 13 wherein mapping includes mapping a plurality of non-overlapping blocks of the extended key on a 1 to 1 basis to a plurality of different multi-bit sequences.

15. The method according to claim 13 wherein mapping includes segmenting the extended key into a plurality of disjointed running keys.

16. The method according to claim 15, wherein the running keys are consecutive non-overlapping groups of the extended key.

17. The method according to claim 15, including using the running keys to select a basis on which to encrypt each bit of the binary bit sequence.

18. The method according to claim 17, wherein the bases correspond to orthogonal pairs of polarization-states.

19. The method according to claim 18, wherein decoding includes flipping each received bit as a function of the mapped extended key.

20. The method according to claim 17, wherein the bases correspond to antipodal phase-states.

21. The method according to claim 20, wherein the bits are defined differentially.

22. The method according to claim 21, wherein decoding includes differentially flipping each received bit as a function of the mapped extended key.

23. The method according to claim 13, wherein the mapping of bits onto polarization or phase states is done in a geometrically interleaved way.

24. The method according to claim 13, wherein the selected state to be transmitted undergoes deliberate state randomization prior to entering the quantum-state generator for optical encoding.

25. The method according to claim 13, wherein the deliberate state randomization is carried out by an analog or digital truly random or pseudo random number generator.

26. The method according to claim 13, including amplifying the modulated light wave while the modulated light wave is being transmitted from the first location to the second location.

27. The method according to claim 13, including amplifying the modulated light wave at the first and/or second locations.

28. The method according to claim 13, including wherein decrypting the light wave includes applying the modulated light wave to a pair of phase modulators that are driven by the mapped extended key to produce the decrypted light wave.

29. The method according to claim 13, wherein demodulating the decrypted light wave includes applying the decrypted optical signal to a demodulator formed by an optical circulator and an interferometer.

30. A method for transmitting data from a first location to a second location over an optical communication channel, said method comprising the steps of:
using a shared multi-bit secret key to produce a mapped extended key;
using an encoded binary message and the mapped extended key to select quantum states;
using the selected quantum states to control a quantum state generator to produce an encrypted time mode optical signal for transmission to a receiver over optical channel;
at the receiver,
receiving the encrypted time mode optical signal transmitted over the optical communication channel;
using the same shared multi-bit secret key to produce the mapped extended key;
using the mapped extended key to drive an optical phase modulator to optically decrypt the time mode optical signal; optically decoding the decrypted time mode signal; and
decoding the demodulated time mode optical signal.

31. A method for transmitting data from a first location to a second location over a communication channel, said method comprising the steps of:
extending a multi-bit secret key to produce a multi-bit extended key K, the length of which is substantially greater than the length of the secret key;
segmenting the extended key into a plurality of disjointed blocks of running keys, each of the running keys being r-bits in length;
encrypting data to be transmitted by
producing at the first location a plurality of polarization-mode coherent states of light; and modulating a finite number of the polarization-mode coherent states of light using the running keys to produce a multi-bit information bearing light signal;
transmitting the multibit information bearing light signal over the communication channel from the first location to the second location; and
decrypting the multi-bit information bearing light signal at the second location including
extending the same multi-bit secret key at the second location to produce the extended key, the length of which is substantially greater than the length of the secret key;
segmenting the extended key into a plurality of disjointed blocks of running keys, each of the running keys being r-bits in length;
applying unitary transformations to the received polarization states according to the extended key, wherein the relative phase shift introduced is determined by the extended key generated and applied to the multibit information bearing light signal; and
processing the received information bearing light signal to cancel polarization rotation caused by the communication channel, whereby after the phase shift has been applied, the relative phase shift between the first and second polarization modes is 0 or π radians corresponding to logic 1 and logic 0 bits, respectively, according to the extended key.

32. The method according to claim 31, wherein the communication channel is a guided media.

33. The method according to claim 31, including amplifying the information bearing light signal while the information bearing light signal is being transmitted from the first location to the second location.

34. A system for transmitting encrypted data from a first location to a second location over a communication channel, said system comprising:
a transmitter at the first location, the transmitter including
a key extender for producing an extended key;
a quantum state generator responsive to the extended key and a bit sequence to be transmitted to the second location to produce an encrypted time mode optical signal for transmission to the second location over the communication channel; and
a receiver at the second location, the receiver including
an optical phase modulator receiving the encrypted time mode optical signal transmitted over the communication channel;
a key extender for producing the same extended key to provide a decryption signal for driving the optical phase modulator to optically decrypt the time mode optical signal; and
a decoder responsive to the decrypted time mode optical signal to recover the bit sequence.

35. The system according to claim 34, wherein the transmitter includes an optical amplifier for amplifying the modulated light wave at the first location.

36. The system according to claim 34, wherein the receiver includes an optical amplifier for amplifying the modulated light wave at the second location.

37. The system according to claim 34, wherein the decoder includes a demodulator formed by an optical circulator and an interferometer.

38. The system according to claim 34, wherein the phase modulator includes first and second concatenated phase modulators.
